(19) United States
(12) Patent Application Publication
(10) Pub. No.: US 2016/0071215 A1
(43) Pub. Date: Mar. 10, 2016

(54) SYSTEMS, DEVICES, AND METHODS FOR DETERMINING VALUE OF AN ENTITY BASED ON STOCK PRICE AND FINANCIAL DATA

(71) Applicant: Alexander Wernher, Twin Peaks, CA (US)

(72) Inventor: Alexander Wernher, Twin Peaks, CA (US)

(73) Assignee: Wernher Market Applications, Inc., Twin Peaks, CA (US)

(21) Appl. No.: 14/483,138

(22) Filed: Sep. 10, 2014

(51) Int. Cl. G06Q 40/06

(52) U.S. Cl. CPC G06Q 40/06

(57) ABSTRACT

Embodiments of the present disclosure include a communication network and a financial data computer server coupled to a user computing device through the communication network. The financial data computer server stores and processes financial data information. The user computing device may request and receive, from the financial data computer server, a market price for a primary entity and three variables based on financial data information of the primary entity. Further, the user computing device may render a primary point in a three-dimensional scatter plot of the market price of the primary entity based on the three variables and calculate a spherical distance of the primary point to the origin to determine and compare market price to the intrinsic value of the primary entity based on the spherical distance and a predetermined threshold.

### BACKGROUND

Many people invest in stocks. Further, these people try to understand the trends of market price or last close price of different entities to determine whether to buy or sell a certain stock. The market price or last close price is the stock price of an entity at the end of the business day (i.e. closing bell) of the previous day. The only variable an investor can control in investing in a stock is the price at which to buy or sell the certain stock. Thus, understanding the value (e.g. intrinsic value) of an entity and whether the current stock price is high or low compared to the value may be a significant factor in purchasing a stock for an investor. The goal of many investors is to buy a stock at a low price compared to its (instrinsic) value and sell a stock at a high price compared to its (instrinsic) value.

Stock investors use various methods to determine the value of a stock. Some methods may include analyzing different variables of an entity such as the price to earnings ratio, price to book value ratio, and price to sales ratio over a time period. However, analyzing such variables in singular fashion may not provide an accurate determination of the value of an entity.

Accordingly, there is a need for systems, devices, and methods for determining the value (e.g. intrinsic value) of a stock price of an entity using multiple variables and displaying the value of a stock based on the multiple variables in a visualization that is relatively simple for an investor to discern the (intrinsic) value, i.e. if the market price is low (undervalued) or high (overvalued) compared to the entity's intrinsic value.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system for determining whether a market price is low (undervalued) or high (overvalued) compared the intrinsic value for a stock of an entity in accordance with some embodiments.

FIGS. 2A-C is a three-dimensional scatter plot used in a system for determining whether a market price is low (undervalued) or high (overvalued) compared the intrinsic value for a stock of an entity in accordance with some embodiments.

FIG. 2D is a user interface that shows a modified whisker plot used in a system for determining whether a market price is low (undervalued) or high (overvalued) compared the intrinsic value for a stock of an entity in accordance with some embodiments.

FIG. 3 is a block diagram of a user computing device in a system for determining whether a market price is low (undervalued) or high (overvalued) compared the intrinsic value for a stock of an entity in accordance with some embodiments.

FIG. 4 is a block diagram of a financial data computer server in a system for determining whether a market price is low (undervalued) or high (overvalued) compared the intrinsic value for a stock of an entity in accordance with some embodiments.

FIGS. 5-6 are flowcharts of a method of determining whether a market price is low (undervalued) or high (overvalued) compared the intrinsic value of a stock of an entity in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Embodiments of the present disclosure include systems, devices, and methods for determining whether a market price is low (undervalued) or high (overvalued) compared the intrinsic value for a market price of an entity using multiple variables and displaying the value of a stock based on the multiple variables in visualization that is relatively simple for an investor to discern , i.e. if the market price is low (undervalued) or high (overvalued) compared to the entity's intrinsic value. Such embodiments include a communication network and a financial data computer server coupled to the communication network. The financial data computer server stores and processes financial data information. Further, such embodiments include a user computing device coupled to the financial data computer server through the communication network. The user computing device may request, from the financial data computer server, a market price for a primary entity and three variables based on financial data information of the primary entity. Further, the user computing device may receive, from the financial data computer server, the market price and the three variables. In addition, the user computing device may render a primary point in a three-dimensional scatter plot of the market price of the primary entity based on the three variables. Moreover, the user computing device may calculate a spherical distance of the primary point to the origin. Also, the user computing device may determine whether the market price is low (undervalued) or high (overvalued) compared to the primary entity's intrinsic value based on the spherical distance and a predetermined threshold.

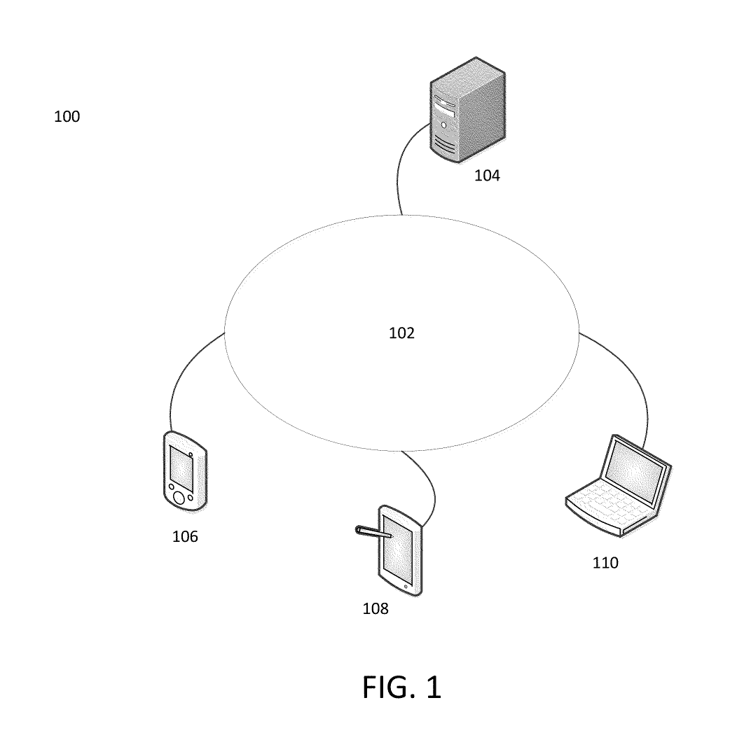

FIG. 1 is a block diagram of a system 100 for determining whether a market price is low (undervalued) or high (overvalued) compared the intrinsic value for a stock of an entity in accordance with some embodiments. The system 100 includes a communication network 102 as well as a financial data computer server 104 coupled to one or more user computing devices (106-110) through the communication network 102. In other embodiments, there may be one or more financial data computer servers that perform the same or similar functionality as the financial data computer server 104 described in the embodiment shown in FIG. 1. Further, the user computing devices (106-110) may include, but not limited to, a smartphone, mobile phone, tablet computer, mobile computer, laptop computer, desktop computer, or any other computing device. In addition, in other embodiments, there may be one or more communication networks coupling financial data computer server(s) to user computing devices. Further such communication networks, including the communication network 102 shown in FIG. 1 may be WiFi, WiMax, wireless, optical, cellular, wired, landline, public telephone switched network (PSTN), Internet, or any other communication network.

The financial data computer server 104 stores or has access to databases that include financial data information for various entities. Such financial information may include, but is not limited to current market price, price to earnings ratio, price to book value ratio, and price to sales ratio over a time period as well as the highest stock price, lowest stock price, starting stock price, ending stock price of the various entities over a time period. Further, the financial data may include the historical, inflation adjusted market price of the various entities over a time period. Not only does the financial data computer server store or access such financial data, but also processes financial data to calculate different financial data metrics. The financial data may also be accessed as variables to be provided to one or more user computing devices (106-110).

A user computing device 110 coupled to the financial data computer server 104 through the communication network 102 may request, from the financial data computer server 104, a market price for a primary entity and three variables based on financial data information of the primary entity. An entity may be a company, a group of companies, a mutual fund, a exchanged traded fund, index fund, index, sector of companies, etc. The variable may be (but not limited to) financial data such as price to earnings ratio, price to book value ratio, and price to sales ratio over a time period, for example. In response to the request, the financial data computer server 104 provides and the user computing device 110 receives from the financial data computer server, the market price and the three variables. In addition, the user computing device 110 may render a primary point in a three-dimensional scatter plot of the market price of the primary entity based on the three variables using one or more modules described herein. Note, in some embodiments, the financial data computer server may process the financial data including the market price and three variables of a primary entity and the way in which such processed data would be rendered on a three-dimensional scatter plot such that the user computing device may need only render the three-dimensional scatter plot on its display. Moreover, the user computing device 110 may calculate a spherical distance of the primary point to the origin of the three-dimensional scatter plot as well as determine if the market price of the primary entity is undervalued or overvalued compared to the primary entity's intrinsic value based on the spherical distance and a predetermined threshold using one or more modules described herein.

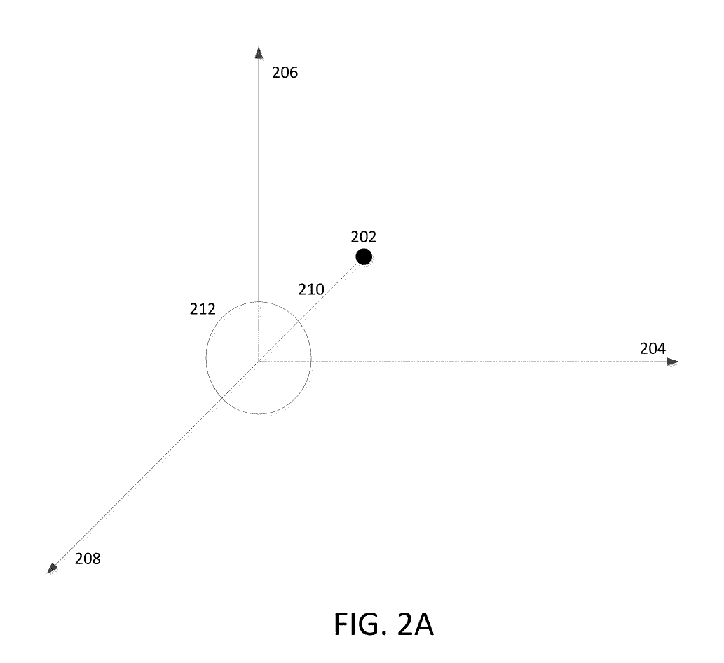

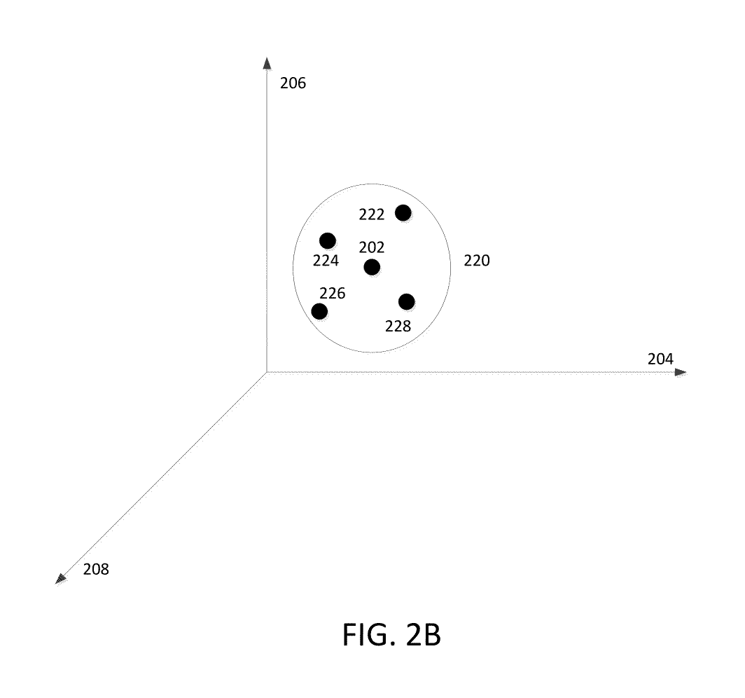

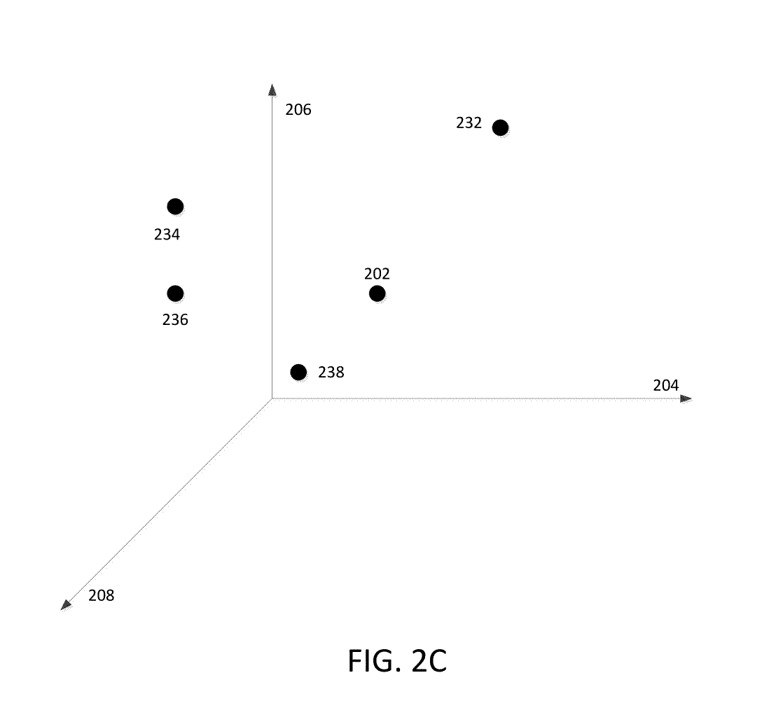

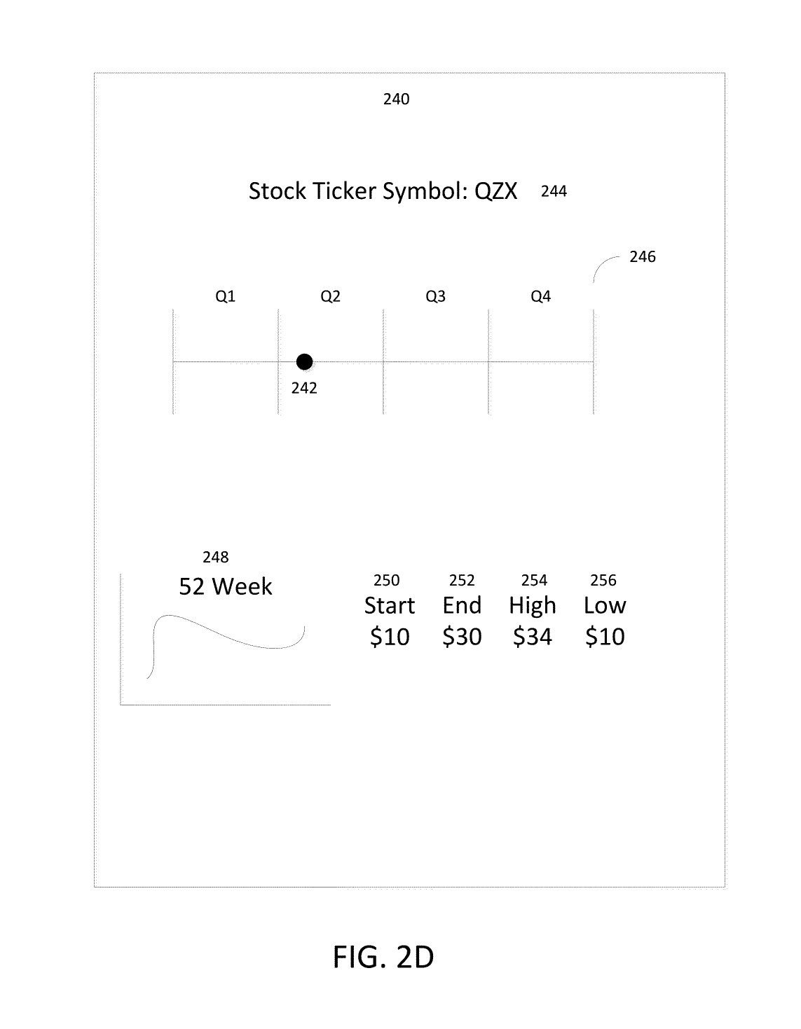

Referring to FIG. 2A, a three-dimensional scatter plot 200 used in a system for determining whether a market price is low (undervalued) or high (overvalued) compared the intrinsic value for a stock of an entity in accordance with some embodiments is shown. Such a three-dimensional scatter plot 200 may be rendered by a user computing device using one or more modules described herein. A primary point 202 is shown that represents the market price of the primary entity in relation to three variables. For example, the x-axis 204 of the 3-D scatter plot 200 may represent the current market price to earnings ratio of the primary entity. Further, the y-axis 206 may represent the current market price to book value ratio of the primary entity. In addition, the z-axis 208 may represent the current market price to sales ratio of the primary entity.

The user computing device may also calculate a spherical distance 210 between the primary point 202 and the origin of the three-dimensional scatter plot. One metric to measure value of a market price may be that the closer the primary point 202 is to the origin, the lower the market price of the primary entity is compared to the primary entity's intrinsic value. Thus, there may be a predetermined threshold that can be represented by a sphere 212 in the three-dimensional scatter plot. Such a predetermined threshold may be configured by the system manufacturer or operator as well as, or instead of, the user. If the primary point 202 is within the predetermined threshold 212, then it may be determined that the market price of the primary entity has a low market price compared to the intrinsic value and an investor may decide to buy the stock. Instead, if the primary point 202 is not within the predetermined threshold 212, then it may be determined that the market price of the primary entity has a high price compared to the intrinsic value and an investor may decide to sell the stock.

Referring to FIG. 2B, a user/investor may want to find secondary entities that have a market price of similar value to the market price of the primary entity. Such secondary entities may be candidates to buy or sell depending on their market price compared to the entities' intrinsic value. The user may input a threshold to find the market price of secondary entities within a certain value range. Such a user inputted threshold may be shown as a sphere 220 on a three-dimensional scatter plot as shown in FIG. 2B that is rendered by a user computing device using one or more modules described herein. Further, the user computing device may request, from a financial data computer server, financial data of the one or more secondary entities within a user inputted threshold of market price of the primary entity. In addition, the user computing device may receive, from the financial data computer server, the market price and three variables of each of the secondary entities. The three variables may be price to earnings ratio, price to book value ratio, and price to sales ratio. Moreover, the user computing device may render one or more secondary points (222-228), each secondary point (222-228) corresponding to each of the one or more secondary entities, in the three-dimensional scatter plot.

Referring to FIG.2C, in other embodiments, the user may input a threshold that is a market price value or a market price range into a user computing device using a user interface. The user computing device may request, from the financial data computer server, financial data of one or more secondary entities within a user inputted market price or range of market prices within or based on the market price of the primary entity. Further, the user computing device may receive, from the financial data computer server, the market price and three variables of each of the secondary entities within the user inputted threshold or range. The three variables may be price to earnings ratio, price to book value ratio, and price to sales ratio. Moreover, the user computing device may render one or more secondary points (232-238), each secondary point (232-238) corresponding to each of the one or more secondary entities, in the three-dimensional scatter plot as shown in FIG. 2C using the modules described herein.

Examining the three-dimensional scatter plot in FIG. 2C, one can see although the market price of each secondary entity may be similar to the market price of the primary entity, the market price compared to the intrinsic value of each secondary entity is different. Secondary points (232-234) show that secondary entities associated with secondary points (232-234) have a higher market price compared to the secondary entities' intrinsic value than primary entity because they are farther way from the origin of three-dimensional scatter plot. Alternatively, the secondary entity associated with the secondary point 236 has a similar market price compared to intrinsic value as the primary entity because this secondary point 236 is a similar distance from the origin as the primary point 202. Further, the secondary entity associated with the secondary point 238 has a lower market price to the secondary entity's intrinsic value than the primary entity because its distance to the origin is less than the distance between the origin and the primary point 202.

In another embodiment, a user may configure the three-dimensional plot on a user computing device using one or more modules described herein such that the size of a primary point and the secondary point represents a value of a fourth variable. For example, a user may request, from the financial data computer server, a fourth variable based on financial data information of the entity. Further, the user computing device may receive, from the financial data computer server, the fourth variable. The fourth variable may be the volume of trading of each stock of the primary entity and the secondary entities from the last business day. Note, the fourth variable may represent any data (e.g. market capitalization, etc.) Further, the user computing device may render the primary point and the secondary points in the three-dimensional scatter plot of the market price of the primary entity such that the size of the primary point or the secondary points are based on the fourth variable. Thus, the larger the size of the primary point and secondary points, the larger the volume of trading for the associated market price, for example.

In an additional embodiment, a user may configure the three-dimensional plot on a user computing device using one or more modules described herein such that the color or other indicator of a primary point and the secondary point represents a value of a fifth variable. For example, a user may request, from the financial data computer server, a fifth variable based on financial data information of the entity. Further, the user computing device may receive, from the financial data computer server, the fifth variable. The fifth variable may represent whether or not the market price associated with the primary point or the secondary points have crossed their respective 52-week high or 52-week low in price, for example, but may represent any financial data. Further, the user computing device may render the primary point and the secondary points in the three-dimensional scatter plot of the market price of the primary entity such that the color or other indicator of the primary point or secondary points are based on the fifth variable. As an example, a point colored red may indicate that the market price is at its 52-week low while a point colored green may indicate that the market price is at its 52-week high.

In a further embodiment, the user may configure the three-dimensional plot on a user computing device using one or more modules described herein such that the three-dimensional scatter plot is animated based on a variable such as time. In such an embodiment, the user computing device may request, from the financial data computer server, a time (or other) variable based on financial data information of the entity. Further, the user computing device may receive, from the financial data computer server, the time variable. In addition, the user computing device may render the primary point and/or secondary points in the three-dimensional scatter plot of the market price of the primary entity such that the primary point and/or secondary points are animated based on the time variable.

In another embodiment, the user may configure the three-dimensional plot on a user computing device using one or more modules described herein such that the primary point or secondary points are flashing based on the value(s) of the point crossing a user inputted or a predetermined threshold. For example, the user computing device may request, from the financial data computer server, a threshold variable based on financial data information of the entity. For example, the threshold variable may be a certain spherical distance to the primary point or secondary point from the origin. Further, the user computing device may receive, from the financial data computer server, the threshold variable. In addition, the user computing device may render the primary point in the three-dimensional scatter plot of the market price of the primary entity such that the primary point or secondary points are flashing based on the market price of the primary entity exceeding or is within the threshold variable.

Referring to FIG. 1, another set of embodiments may include the financial data computer server 104 storing and processing historical inflation adjusted stock price for a primary entity. In one such embodiment, the user computing device 110 may request, from the financial data computer server, historical inflation adjusted stock price information of a primary entity. Further, the user computing device may receive, from the financial data computer server, the historical inflation adjusted stock price of primary entity. In one embodiment, the user computing device may process the historical inflation adjusted stock price information of the primary entity using the modules described herein. In another embodiment, the financial data computer server may process the historical inflation adjusted stock price of the primary entity using the modules described herein. In addition, the user computing device may render the historical inflation adjusted stock price information of the primary entity in a modified box and whisker plot.

Referring to FIG. 2D, a user interface 240 that shows a modified box and whisker plot used in a system for determining whether a market price is low (undervalued) or high (overvalued) compared the intrinsic value for a stock of an entity in accordance with some embodiments is shown. Such a user interface 240 may be displayed on a user computing device using modules described herein. In some embodiments, a financial data computer server may store or have access to historical inflation adjusted stock price information for a primary entity. The user computing device may request the historical inflation adjusted stock price information of the primary entity and the request the value of the current stock price of the primary entity with respect to the historical inflation adjusted stock price information. Upon receiving such information from the financial data computer server, the user computing device may render a modified box and whisker plot 246 for the primary entity (with stock ticker symbol QZX 244). The modified box and whisker plot 246 breaks down the historical inflation adjusted stock price into quartiles and displays the current or last close market price of the stock of the primary entity 242 within the modified box and whisker plot 246.

In the embodiment shown in FIG. 2D, the current stock price is in the lower end of the second quartile. A user/investor may determine upon examining such data in the modified box and whisker plot 246 that the primary entity may be undervalued at this time and decide to buy stock in the primary entity. Further, the user interface 240 may show the stock price fluctuation of the primary entity in a chart 248. In addition, the user interface 240 may show the start 250, end 252, high 254, and low 256 of the stock price of the 52 week time period. Although the user interface 240 shows data (248-256) over a 52 week time period, other embodiments may show data over any time period.

In further embodiments, the user computing device may determine one or more variables based on the historical inflation adjusted stock price information of the primary entity and rendering a chart displaying the one or more variables. For example, instead of display chart 248 and data 250-256 of the current stock price over the previous 52 week period, the user computing device may determine the historical inflation adjusted stock price of the primary entity over the previous 52 week period in a chart as well as display the start, end, high and low of the historical inflation adjusted stock price over the previous 52 week period.

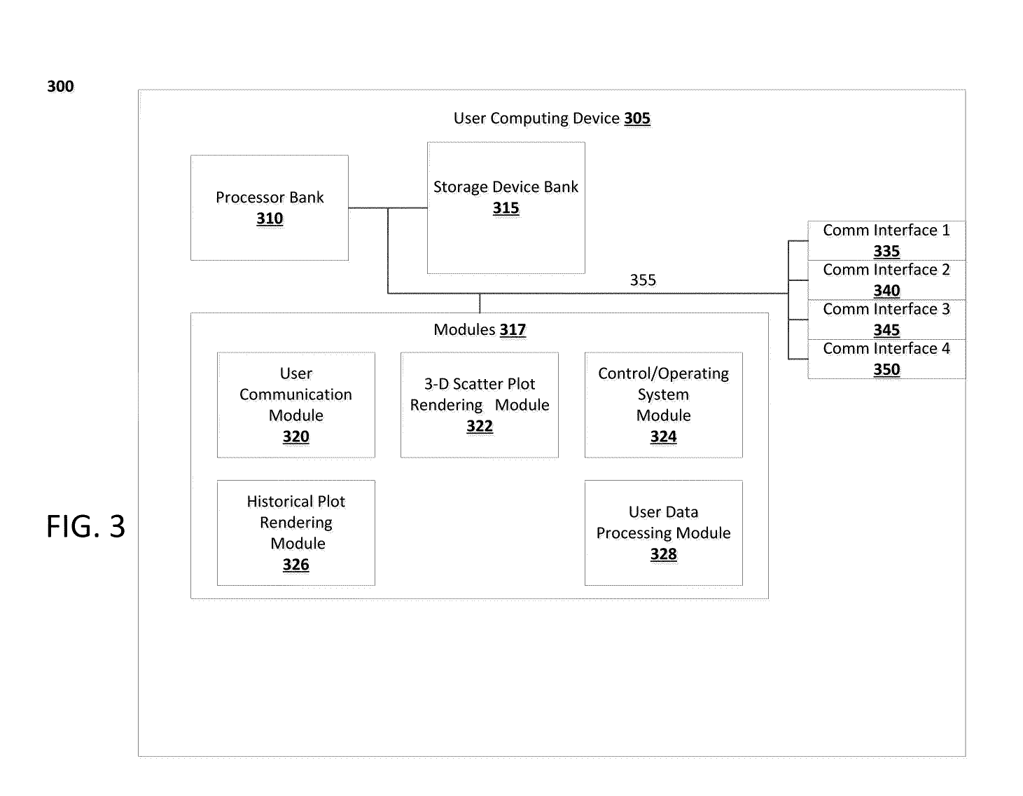

FIG. 3 is a block diagram of a user computing device in a system for determining whether a market price is low (undervalued) or high (overvalued) compared the intrinsic value for a stock of an entity in accordance with some embodiments. Such a user computing device 305 may be used in a system shown in FIG. 1. Further, the user computing device 305 may be, but not limited to, a smartphone, mobile phone, tablet computer, mobile computer, laptop computer, desktop computer, or any other computing device. The user computing device 305 may include several different components such as a processor bank 310, storage device bank 315, one or more software applications, which may be executed by a processor. Thus, the combination of the software applications as well as the processor and any other hardware form specifically-configured module devices 317. The user computing device 305 also has one or more communication interfaces (335-350). The processor bank 310 may include one or more processors that may be co-located with each other or may be located in one module or in different parts of the user computing device 305. The storage device bank 315 may include one or more storage devices. Types of storage devices may include electronic memory, optical memory, and removable storage media. The one or more modules 317 may include a user communication module 320, a three dimensional (3-D) scatter plot module 322, control/operating system (OS) system module 324, historical plot rendering module 326, and user data processing module 328. The modules 317 may be implemented by the one or more processors in the processor bank 310.

The user communication module 320 allows the user computing device 305 to communicate with a user or with one or more computer servers such as a financial data computer server described herein over the one or more communication interfaces (335-350). The user communication module 320 may support different communication technologies that include, but are not limited to, Ethernet, WiFi, WiMax, wireless, optical, cellular, or any other communication technology. Further, the user communication module 320 may send a request to and/or receive information from the financial data computer server as described herein.

The three-dimensional scatter plot rendering module 322 may receive financial data information from the user communication module 320 or the user data processing module 328 and render a three-dimensional scatter plot of the financial data information on the user interface or display of the user computing device 305. The three-dimensional scatter plot may be one of the scatter plots shown in FIGS. 2A-C and variations thereof. For example, the financial data information may be the current market price of a primary entity as well as the price to earnings ratio, price to book value ratio, and price to sales ratio of the primary entity over the time period. The three-dimensional scatter plot rendering module may process the data in conjunction with the user data processing module 328 to render a three-dimensional scatter plot on the user interface similar to the three-dimensional scatter plot shown in FIG. 2A.

The control/OS module 324 may include control software applications that implement software functions that assist in performing certain tasks for the user computing device 305 such as providing access to a communication link (e.g. wired, wireless, Bluetooth, infra-red, RF, etc.), executing an operating system, managing software drivers for peripheral components, and processing information. In addition, the control/OS module 324 may also include software drivers for peripheral components, user interface computer programs, debugging and troubleshooting software tools. Also, the control/OS module 324 may include an operating system supported by the sensor provider computer server. Such operating systems are known in the art for such servers but may also include computer operating systems (e.g. Windows, Linux, UNIX, previous version of Windows and MacOS, etc.).

The historical plot rendering module 326 may receive financial data information such as historical inflation adjusted stock price information from the financial data computer server through the user communication module 320 or the user data processing module 328 and render a modified box and whisker plot of the financial data information on the user interface or display of the user computing device 305. The modified box and whisker plot may be similar to the one shown in FIG. 2D and variations thereof. Further, the historical plot rendering module may process the data in conjunction with the user data processing module 328 to render a modified box and whisker plot on the user interface similar to the modified box and whisker plot shown in FIG. 2D.

The user data processing module 328 may process data received from the user through a user interface (e.g. a user inputted threshold or spherical distance as described herein) or process data received from the financial data computer server. As described herein, the user data processing module 328 may work in conjunction with either the three-dimensional scatter plot module 322 or the historical plot rendering module 326 to render a three-dimensional scatter plot or modified box and whisker plot, respectively. Further the user data processing module 328 may process financial data associated with the primary entity including the stock price of the primary entity over the previous 52-week period as well as the start, end, high and low of the stock price over such a period. In addition, the user data processing module 328 may cause to display such data on a user interface as shown in FIG. 2D.

Each of the communication interfaces (335-350) may be software or hardware associated in communicating to other devices. The communication interfaces (335-350) may be of different types that include a user interface, USB, Ethernet, WiFi, WiMax, wireless, optical, cellular, or any other communication interface coupled to a communication network. One or more of the communication interfaces (335-350) may be coupled to a user interface known in the art, inter alia, for installation and diagnostic purposes.

Note, some or all of the functions implemented by the modules in the user computing device may be implemented by the modules of the financial data computer server.

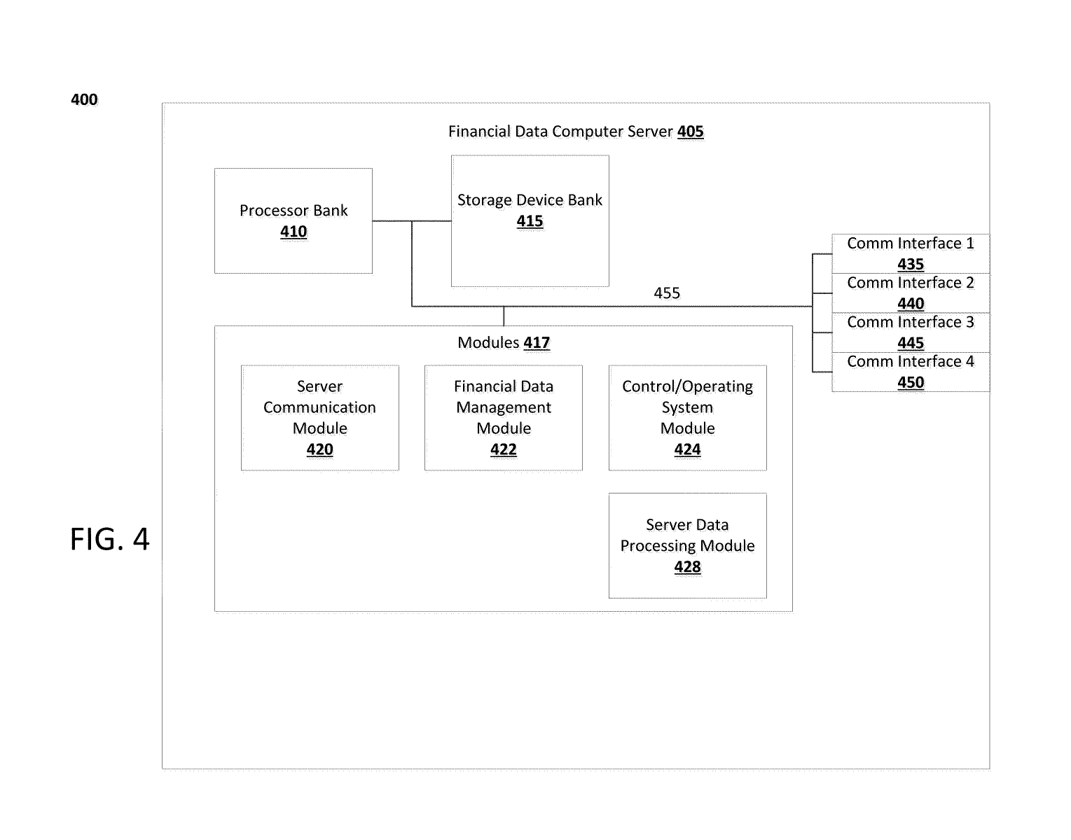

FIG. 4 is a block diagram of a financial data computer server in a system for determining whether a market price is low (undervalued) or high (overvalued) compared the intrinsic value for a stock of an entity in accordance with some embodiments. Such a financial data computer server 405 may be used in a system shown in FIG. 1. Further, the financial data computer server 405 may be one computer server or represent more than one computer server in a computer server system such that each computer server in the computer server system may be co-located or not in the same location of the other computer servers in the computer server system.

The financial data computer server 405 may include several different components such as a processor bank 410, storage device bank 415, one or more software applications, which may be executed by a processor. Thus, the combination of the software applications as well as the processor and any other hardware form specifically-configured module devices 417. The financial data computer server 405 also has one or more communication interfaces (435-450). The processor bank 410 may include one or more processors that may be co-located with each other or may be located in one module or in different parts of the financial data computer server 405. The storage device bank 415 may include one or more storage devices. Types of storage devices may include electronic memory, optical memory, and removable storage media. The one or more modules 417 may include a server communication module 420, financial data management module 422, control/operating system (OS) system module 424, and server data processing module 428. The modules 417 may be implemented by the one or more processors in the processor bank 410.

The server communication module 420 allows the financial data computer server 405 to communicate with one or more user computing devices and/or one or more financial databases described herein over the one or more communication interfaces (335-350). The server communication module 420 may support different communication technologies that include, but are not limited to, Ethernet, WiFi, WiMax, wireless, optical, cellular, or any other communication technology. Further, the server communication module 420 may send a request to and/or receive information from the financial database, or respond to a request from a user computing device and provide financial data to such a user computing device as described herein.

The financial data management module 422 accesses and stores financial data in the financial database (either on another computer device or on its own storage device bank 415). Further, when a request for financial data information is received form a user computing device, the financial data management module 422 may access such financial data from the financial database and provide such financial data to the user computing device (using the server communication module 420).

The control/OS module 424 may include control software applications that implement software functions that assist in performing certain tasks for the financial data computer server 405 such as providing access to a communication link (e.g. wired, wireless, Bluetooth, infra-red, RF, etc.), executing an operating system, managing software drivers for peripheral components, and processing information. In addition, the control/OS module 424 may also include software drivers for peripheral components, user interface computer programs, debugging and troubleshooting software tools. Also, the control/OS module 424 may include an operating system supported by the sensor provider computer server. Such operating systems are known in the art for such servers but may also include computer operating systems (e.g. Windows, Linux, UNIX, previous version of Windows and MacOS, etc.).

The server data processing module 428 may process data received from the user computing device (e.g. a user inputted threshold or spherical distance as described herein) or process data based on request from the user computing device. As described herein, the server data processing module 428 may work in conjunction with the server communication module and financial data management module to receive/process requests and financial data and provide such processed data to the user computing device as described herein.

Each of the communication interfaces (435-450) may be software or hardware associated in communicating to other devices. The communication interfaces (435-450) may be of different types that include a user interface, USB, Ethernet, WiFi, WiMax, wireless, optical, cellular, or any other communication interface coupled to a communication network. One or more of the communication interfaces (435-450) may be coupled to a user interface known in the art, inter alia, for installation and diagnostic purposes.

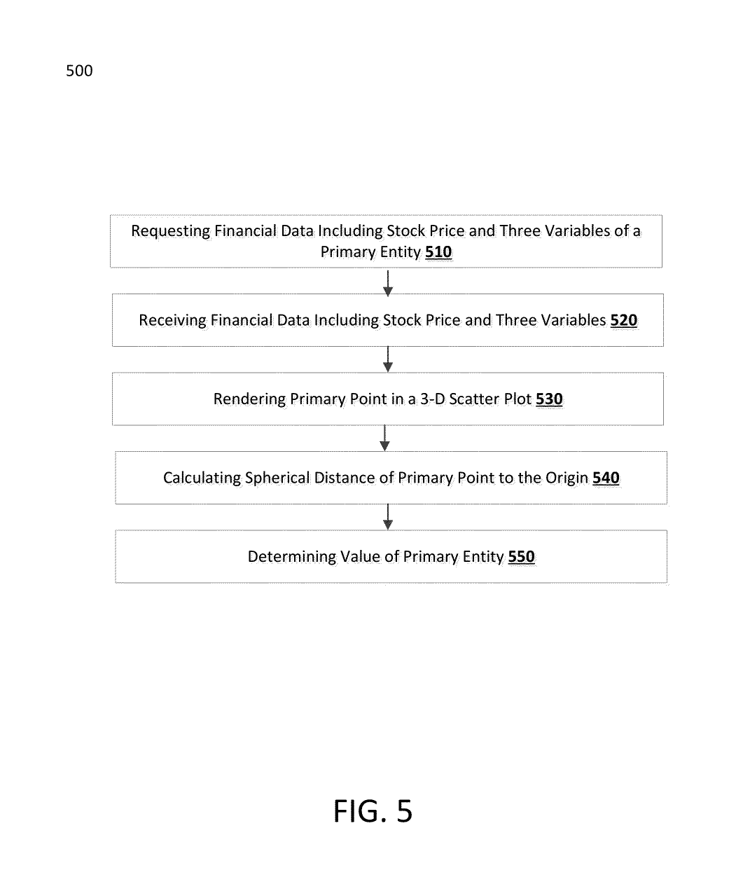

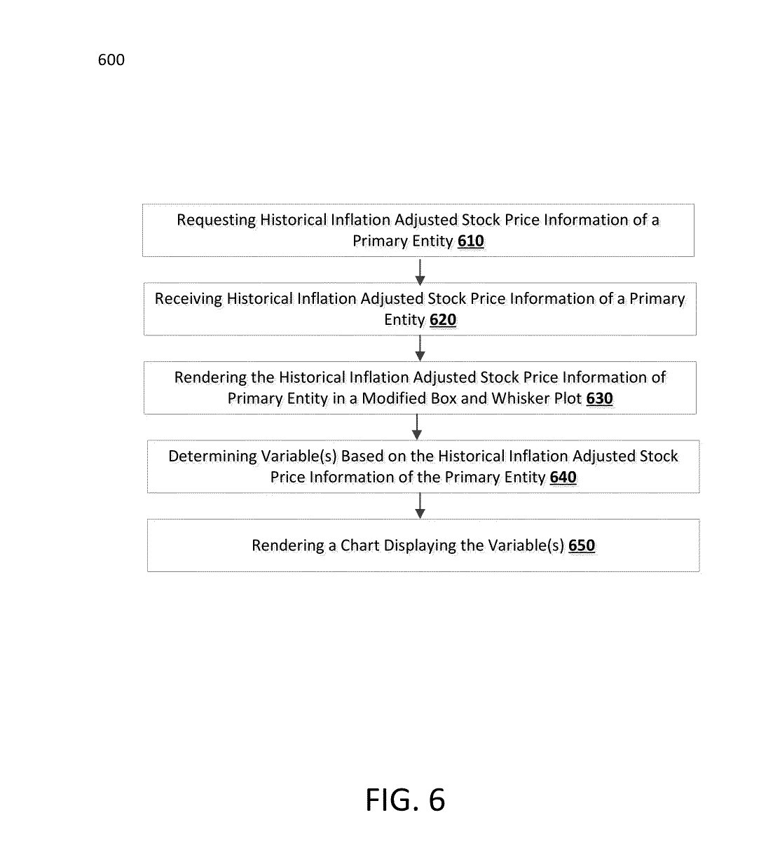

FIGS. 5-6 are flowcharts of a method of determining whether a market price is low (undervalued) or high (overvalued) compared the intrinsic value of a stock of an entity in accordance with some embodiments. Referring to FIG. 5, the method 500 includes a user computing device requesting financial data including a market price and three variables of a primary entity, as shown in block 510. The three variables may be price to earnings ratio, price to book value ratio, and price to sales ratio of the primary entity over a time period. Further, the method 500 includes the user computing device receiving the financial data include the market price and three variables of the primary entity, as shown in block 520. In addition, the method 500 includes rendering a primary point in a three dimensional scatter plot on the user computing device, as shown in block 520. Each of the axes of the three-dimensional scatter plot may correspond to one of the three variables in the financial data. Moreover, the method 500 includes the user computing device calculating a spherical distance of the primary point to the origin of the three-dimensional scatter plot, as shown in block 540. Also, the method 500 includes the user computing device determining whether the market price is high or low compared to the intrinsic value of the primary entity based on the calculated spherical distance, as shown in block 550. Such a determination may be based on a system configured, predetermined threshold or by a user inputted threshold.

Referring to FIG. 6, the method 600 includes a user computing device requesting, from a financial data computer server, historical inflation adjusted stock price information of a primary entity, as shown in block 610. Further, the method 600 includes the user computing device receiving, from the financial data computer server, historical inflation adjusted stock price information of a primary entity, as shown in block 620. Further, the method 600 includes the user computing device rendering the historical inflation adjusted stock price information of the primary entity in a modified box and whisker plot, as shown in block 630. In addition, the method 600 includes the user computing device determining one or more variables based on the historical inflation adjusted stock price information of the primary entity, as shown in block 640. For example, the user computing device (as well as the financial data computer server in other embodiments) may determine the start, end, high, and low of the stock price in terms of the historical inflation adjusted stock price information over a time period. In another embodiment, the user computing device may request, receive and process the stock price information that is not adjusted for inflation to determine the start, end, high, and low of the stock price over a time period. Moreover, the method 600 includes the user computing device rendering a chart displaying the variables, as shown in block 650.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A system, comprising:
a communication network;
a financial data computer server coupled to the communication network, the financial data computer server storing and processing financial data information;
a user computing device coupled to the financial data computer server through the communication network, the user computing device:
(a) requesting, from the financial data computer server, a market price for a primary entity and three variables based on financial data information of the primary entity;
(b) receiving, from the financial data computer server, the market price and the three variables;
(c) rendering a primary point in a three-dimensional scatter plot of the market price of the primary entity based on the three variables;
(d) calculating a spherical distance of the primary point to the origin;
(e) determining the market price compared to the instrinsic value of the primary entity based on the spherical distance and a predetermined threshold.

2. The system of claim 1, wherein the user computing device:
(a) requesting, from the financial data computer server, financial data of one or more secondary entities within a user inputted threshold of market price of the primary entity;
(b) receiving, from the financial data computer server, the market price and three variables of each of the secondary entities;
(c) rendering one or more secondary points, each corresponding to each of the one or more secondary entities, in the three-dimensional scatter plot.

3. The system of claim 1, wherein the user computing device:
(a) requesting, from the financial data computer server, financial data of one or more secondary entities within a user inputted spherical distance of the primary point of the primary entity;
(b) receiving, from the financial data computer server, the market price and three variables of each of the secondary entities within the user inputted spherical distance;
(c) rendering one or more secondary points, each corresponding to each of the one or more secondary entities, in the three-dimensional scatter plot.

4. The system of claim 1, wherein the user computing device:
(a) requesting, from the financial data computer server, a fourth variable based on financial data information of the entity;
(b) receiving, from the financial data computer server, the fourth variable;
(c) rendering the primary point in the three-dimensional scatter plot of the market price of the primary entity wherein the size of the primary point is based on the fourth variable.

5. The system of claim 1, wherein the user computing device:
(a) requesting, from the financial data computer server, a fifth variable based on financial data information of the entity;
(b) receiving, from the financial data computer server, the fifth variable;
(c) rendering the primary point in the three-dimensional scatter plot of the market price of the primary entity wherein the color of the primary point is based on the fifth variable.

6. The system of claim 1, wherein the user computing device:
(a) requesting, from the financial data computer server, a time variable based on financial data information of the entity;
(b) receiving, from the financial data computer server, the time variable;
(c) rendering the primary point in the three-dimensional scatter plot of the market price of the primary entity wherein the primary point is animated based on the time variable.

7. The system of claim 1, wherein the user computing device:
(a) requesting, from the financial data computer server, a threshold variable based on financial data information of the entity;
(b) receiving, from the financial data computer server, the threshold variable;
(c) rendering the primary point in the three-dimensional scatter plot of the market price of the primary entity wherein the primary point is flashing based on the market price of the primary entity exceeding the threshold variable.

8. A system, comprising:
a communication network;
a financial data computer server coupled to the communication network, the financial data computer server storing and processing financial data information;
a user computing device coupled to the financial data computer server through the communication network, the user computing device:
(a) requesting, from the financial data computer server, historical inflation adjusted stock price information of a primary entity;
(b) receiving, from the financial data computer server, the historical inflation adjusted stock price of primary entity;
(c) rendering the historical inflation adjusted stock price information of the primary entity in a modified box and whisker plot.

9. The system of claim 8, wherein the user computing device:
(a) determining one or more variables based on the historical inflation adjusted stock price information of the primary entity;
(b) rendering a chart displaying the one or more variables.

10. The system of claim 8, wherein the one or more variables are based on a time period.

11. The system of claim 10, wherein the one or more variables include a highest stock price within the time period, a lowest stock price within the time period, a start price within the time period and an end price within the time period.

12. The system of claim 10, wherein the entity includes at least one of a company, sector, index, mutual, and exchange traded fund.
